(19) United States
(12) Patent Application Publication
(10) Pub. No.: US 2010/0007059 A1
(43) Pub. Date: Jan. 14, 2010

(54) METHOD IN SPINNING

(76) Inventors: Yury Rochev, Dangan (IE); Terry Smith, Galway (IE); Valerie Barron, Kilcolgan (IE); Aaron Tonry, Via Boyle (IE); Pertti Nousiainen, Tampere (FI); Arja Puolakka, Tampere (FI); Marja Rissanen, Lempaala (FI)

Correspondence Address: VENABLE LLP, P.O. BOX 34385, WASHINGTON, DC, 20043-9998, US

(21) Appl. No.: 12/499,304

(22) Filed: Jul. 8, 2009

Related U.S. Application Data
(60) Provisional application No. 61/078,961, filed on Jul. 8, 2008.

(51) Int. Cl. B29C 47/36

(52) U.S. Cl. 264/442

(57) ABSTRACT

A method in spinning including introducing a first solution comprising a polymer, introducing a second solution comprising a biomolecule, combining the first and the second solution into a mixture, treating the mixture with a sonicator to form a spinning solution, and wet spinning the spinning solution.

### CROSS-REFERENCE TO RELATED APPLICATIONS

This application claims priority to U.S. provisional patent application 61/078,961 filed Jul. 8, 2008.

### FIELD OF THE INVENTION

The present invention relates to a method in spinning.

### BACKGROUND OF THE INVENTION

One way to prepare a spinning solution is to grind the biomolecule and add it by stirring to a spinning solution. The present inventors have discovered that in preparing spinning solutions containing biomolecules there is a problem that it is not possible to spin fibers through spinning nozzles whose hole diameter is small because the spinning solution tends to block the spinning nozzles due to large biomolecule particles.

### SUMMARY OF THE INVENTION

The aim of the invention is to introduce a method in spinning by which method it is also possible to spin through spinning nozzles having a small hole diameter.

In the method, a first solution comprising a polymer and a second solution comprising a biomolecule are introduced. The polymer is usually a biodegradable and bioresorbable polymer, such as polylactic acid (PLA), polyglycolic acid (PGA), polycaprolactone (PCL) or their mixtures. The polymer is typically dissolved in a suitable solvent. For example, dichloromethane is a suitable solvent for a polylactic acid. The typical polymer concentration of the first solution is from 6 to 15 wt.-% preferably from 8 to 10 wt.-%.

The biomolecule is such that it improves the cell cultivation because the obtained fibers are used for scaffolds for the cell cultivation. From the present fibers it is possible, for example, to prepare blanks for heart valves. The biomolecule may be one of the following growth factors: vascular endothelial growth factor (VEGF, important signaling proteins involved in vasculogenesis and angiogenesis), fibroblast growth factors, (FGF, a family of growth factors involved in angiogenesis, wound healing), transforming growth factor (TGF, sometimes referred to as Tumor growth factor, play crucial roles in tissue regeneration), bone morphogenetic proteins (BMPs, a group of growth factors and cytokines known for their ability to induce the formation of bone and cartilage) and epidermal growth factor (EGF, involved in cell migration, adhesion, and proliferation).

The biomolecule is typically a protein, such as albumin, or a peptide. The peptides, which can be incorporated into the fibers, are synthetic or natural, linear or cyclic peptides. The peptides include, for example, antimicrobial peptides (such as defensin), anti-inflammatory peptides (such as anti-inflammatory peptide 1), immunosuppressants ( such as cyclosporine), and neuropeptides (such as beta-endorfine).

The biomolecule is dissolved in a suitable solvent, such as water. The amount of the biomolecule is typically from 0.1 to 0.4 wt.-%, preferably 0.24 to 0.26 wt.-%, calculated from the amount of the polymer.

The first and the second solution are combined into a mixture. The mixture is treated with a sonicator typically for two to five minutes so that a homogenous solution is formed due to the sound energy directed to it. Typically the sound energy is ultrasound energy. The resulted spinning solution only contains nanoscale particles and therefore, the solution is suitable for spinning through small diameter holes.

After the sonication, the spinning solution is spun to fibers by a wet spinning method. The spinning solution is spun through a spinning nozzle, which typically comprises more than one hole, i.e. the spinning nozzle is for manufacturing many filaments at a time. The diameter of the hole is typically from 50 to 100 μm. The fibers are led from the nozzle to a spinning bath so that a suitable drawing ratio is used. The fibers are coagulated in the spinning bath. The spinning bath may comprise or consist of alcohol, such as methanol or ethanol. The diameter of the fibers is typically between 10 and 60 μm, usually between 10 to 20 μm.

### BRIEF DESCRIPTION OF THE DRAWINGS

FIG. 1 represents a photomicrograph showing a biomolecule inside a fiber; and

FIG. 2 represents a photomicrograph showing a biomolecule inside a fiber.

### DETAILED DESCRIPTION OF EMBODIMENTS OF THE INVENTION

In the following, the invention will be described by several examples:

### EXAMPLE 1

4 g PLA 70/30 (70/30 Purac biochem by Gorinchem, P(UDL)LA: lot. 0511000205 i.v. 3.07 dl/g) was added to 50 ml dichloromethane so that an 8 wt.-% solution was obtained (first solution). 0.01 g albumin (albumin from bovine serum, Sigma) was added to 2.5 ml water (second solution). The first and the second solution were combined and treated with a sonicator (Soniprep 150 Ultrasonic disintegrator, MSE Scientific Instruments, amplitude 24) for two minutes to obtain a spinning solution. The spinning solution was spun through a spinning nozzle containing 20 holes having a diameter of 0.1 mm. The speed of the spinning (gear) pump was 5 rpm and the drawing speed was 8 m/min. The obtained fibers were coagulated in an ethanol bath. Test results of the obtained fibers are shown in Table 1.

### EXAMPLE 2

5 g PLA 70/30 i.v. 3.07 dl/g was added to 50 ml dichloromethane so that a 10 wt.-% solution was obtained (first solution). 0.01 g albumin (albumin from bovine serum, Sigma) was added to 2.5 ml water (second solution). The first and the second solution were combined and treated with a sonicator (Soniprep 150 Ultrasonic disintegrator, MSE Scientific Instruments, amplitude 24) for four minutes to obtain a spinning solution. The spinning solution was let stand for 20 minutes before spinning. The spinning solution was spun through a spinning nozzle containing 20 holes having a diameter of 0.1 mm. The speed of the spinning (gear) pump was 5 rpm and the drawing speed was 8 m/min. The obtained fibers were coagulated in an ethanol bath. Test results of the obtained fibers are shown in Table 1.

### EXAMPLE 3

4 g PLA 70/30 i.v. 3.07 dl/g was added to 50 ml dichloromethane so that an 8 wt.-% solution was obtained (first solution). 0.01 g albumin (Fluorescein isothiocyanate conjugate bovine, Sigma) was added to 2.5 ml water (second solution). The first and the second solution were combined and treated with a sonicator (Soniprep 150 Ultrasonic disintegrator, MSE Scientific Instruments, amplitude 24) for two and half minutes to obtain a spinning solution. The spinning solution was spun through a spinning nozzle containing 20 holes having a diameter of 0.1 mm. The speed of the spinning (gear) pump was 5 rpm and the drawing speed was 8 m/min. The obtained fibers were coagulated in an ethanol bath. Test results of the obtained fibers are shown in Table 1.

### EXAMPLE 4

3.2 g PLA 70/30 i.v. 3.07 dl/g was added to 40 ml dichloromethane so that an 8 wt.-% solution was obtained (first solution). 0.008 g albumin (Fluorescein isothiocyanate conjugate bovine, Sigma) was added to 2.286 ml water (second solution). The first and the second solution were combined and treated with a sonicator (Hielscher UP2005, Ultrasonic processor, amplitude 125 μm, cycle 0.7) for 2 min 15 s to obtain a spinning solution. The spinning solution was spun through a spinning nozzle containing 20 holes having a diameter of 0.1 mm. The speed of the spinning (gear) pump was 9.7 rpm and the drawing speed was 3.5 m/min. The obtained fibers were coagulated in an ethanol bath. Test results of the obtained fibers are shown in Table 1.

### EXAMPLE 5

3.6 g PLA 70/30 i.v. 3.07 dl/g was added to 40 ml dichloromethane so that a 9 wt.-% solution was obtained (first solution). 0.009 g albumin (Fluorescein isothiocyanate conjugate bovine, Sigma) was added to 2.571 ml water (second solution). The first and the second solution were combined and treated with a sonicator (Hielscher UP2005, Ultrasonic processor, amplitude 125 μm, cycle 0.7) for three minutes to obtain a spinning solution. The spinning solution was let stand for 20 minutes before spinning. The spinning solution was spun through a spinning nozzle containing 20 holes having a diameter of 0.1 mm. The speed of the spinning (gear) pump was 9.7 rpm and the drawing speed was 3.5 m/min. The obtained fibers were coagulated in an ethanol bath. Test results of the obtained fibers are shown in Table 1.

### EXAMPLE 6

3.6 g PLA 70/30 i.v. 3.07 dl/g was added to 40 ml dichloromethane so that a 9 wt.-% solution was obtained (first solution). 0.009 g albumin (Fluorescein isothiocyanate conjugate bovine, Sigma) was added to 2.571 ml water (second solution). The first and the second solution were combined and treated with a sonicator (Hielscher UP2005, Ultrasonic processor, amplitude 125 μm, cycle 0.7) for three minutes to obtain a spinning solution. The spinning solution was let stand for 20 minutes before spinning. The spinning solution was spun through a spinning nozzle containing 20 holes having a diameter of 0.1 mm. The speed of the spinning (gear) pump was 9.7 rpm and the drawing speed was 6.5 m/min. The obtained fibers were coagulated in an ethanol bath. Test results of the obtained fibers are shown in Table 1.

### EXAMPLE 7

4 g PLA 70/30 i.v. 3.07 dl/g was added to 40 ml dichloromethane so that a 10 wt.-% solution was obtained (first solution). 0.01 9 albumin (Fluorescein isothiocyanate conjugate bovine, Sigma) was added to 2.857 ml water (second solution). The first and the second solution were combined and treated with a sonicator (Hielscher UP2005, Ultrasonic processor, amplitude 125 μm, cycle 0.7) for five minutes to obtain a spinning solution. The spinning solution was let stand for 20 minutes before spinning. The spinning solution was spun through a spinning nozzle containing 20 holes having a diameter of 0.1 mm. The speed of the spinning (gear) pump was 9.7 rpm and the drawing speed was 7 m/min. The obtained fibers were coagulated in an ethanol bath. Test results of the obtained fibers are shown in Table 1.

### EXAMPLE 8

4 g PLA 70/30 i.v. 3.07 dl/g was added to 40 ml dichloromethane so that a 10 wt.-% solution was obtained (first solution). 0.01 g albumin (Fluorescein isothiocyanate conjugate bovine, Sigma) was added to 2.857 ml water (second solution). The first and the second solution were combined and treated with a sonicator (Hielscher UP2005, Ultrasonic processor, amplitude 125 μm, cycle 0.7) for five minutes to obtain a spinning solution. The spinning solution was let stand for 20 minutes before spinning. The spinning solution was spun through a spinning nozzle containing 20 holes having a diameter of 0.1 mm. The speed of the spinning (gear) pump was 9.7 rpm and the drawing speed was 10 m/min. The obtained fibers were coagulated in an ethanol bath. Test results of the obtained fibers are shown in Table 1.

TABLE 1
Test results.

| | Titer (dtex) | | | Tenacity (cN/dtex) | | | Elong. (%) | | | Force (cN) | | | Diameter (mm) | | |
|---|---|---|---|---|---|---|---|---|---|---|---|---|---|---|---|
| Specimen | Mean | Dev. | CV (%) | Mean | Dev. | CV (%) | Mean | Dev. | CV (%) | Mean | Dev. | CV (%) | Mean | Dev. | CV (%) |
| Example 1 | 4.73 | 2.14 | 45.30 | 0.39 | 0.25 | 63.60 | 82.80 | 47.50 | 57.40 | 1.49 | 0.67 | 44.80 | 0.034 | 0.00866 | 25.5 |
| Example 2 | 5.48 | 1.24 | 22.60 | 0.38 | 0.06 | 16.20 | 94.90 | 17.00 | 18.00 | 2.04 | 0.36 | 17.6 | 0.029 | 0.00915 | 31.6 |
| Example 3 | 6.20 | 1.45 | 23.30 | 0.26 | 0.06 | 23.60 | 87.70 | 43.10 | 49.20 | 1.56 | 0.36 | 22.7 | 0.029 | 0.00665 | 23.3 |
| Example 4 | 15.72 | 1.05 | 6.70 | 0.12 | 0.01 | 10.20 | 36.90 | 31.80 | 86.10 | 1.94 | 0.24 | 12.2 | 0.054 | 0.00612 | 11.3 |
| Example 5 | 14.69 | 1.64 | 11.20 | 0.12 | 0.01 | 11.20 | 20.60 | 17.90 | 87.10 | 1.77 | 0.28 | 15.7 | 0.058 | 0.01034 | 17.9 |
| Example 6 | 15.40 | 2.17 | 14.10 | 0.14 | 0.02 | 15.10 | 25.70 | 23.70 | 92.20 | 2.11 | 0.46 | 21.90 | 0.058 | 0.00875 | 15.2 |
| Example 7 | 12.03 | 2.32 | 19.30 | 0.16 | 0.02 | 12.20 | 44.80 | 37.50 | 83.80 | 1.89 | 0.40 | 21.40 | 0.043 | 0.00836 | 19.4 |
| Example 8 | 13.64 | 2.19 | 16.00 | 0.15 | 0.03 | 17.20 | 64.60 | 44.60 | 69.00 | 2.08 | 0.43 | 20.60 | 0.039 | 0.00492 | 12.8 |

Test methods:
Titer: SFS-EN ISO 1973 (Textile fibres. Determination of linear density. Gravimetric and vibroscope method.)
Tenacity, elongation, force: SFS-EN ISO 5079 (Textile fibres - Determination of breaking force and elongation at break of individual fibres).
Diameter: SFS 4463 Determination of fibre diameter. Projection microscope method.

### EXAMPLE 9

Two different biomolecule adding methods were studied. The first one was the grinding method and the second was the sonication method. Fibre modification was done by adding biomolecule into the wet-spun fibres. The added amounts were 0.24% from the weight of polymer. The used biomolecule was Albumin Fluorescein isothiocyanate Conjugate bovine (Sigma). Polymer was 70/30 Purac biochem by Gorinchem, P(L/DL)LA, i.v. 3.07 dl/g. Polymer concentration was 8 or 10%. Solvent was dichloromethane and coagulant ethanol or methanol.

In the grinding method the biomolecule was ground to powder and filtrated. The maximum diameter of the Albumin particles was 30 μm. The albumin was added to dichloromethane with magnetic stirrer before polymer. After dissolution of the polymer fibres were wet spun. Drawing velocity was 30 m/min. After only a few minutes of spinning the spinnerettes were blocked by biomolecule and spinning was impossible.

New spinneret was purchased from Enka Technica. It has only 10 holes and the diameter of the holes was 0.15 mm (compared to normally used spinneret 20×0.1). The spinning time increased slightly with the new spinneret.

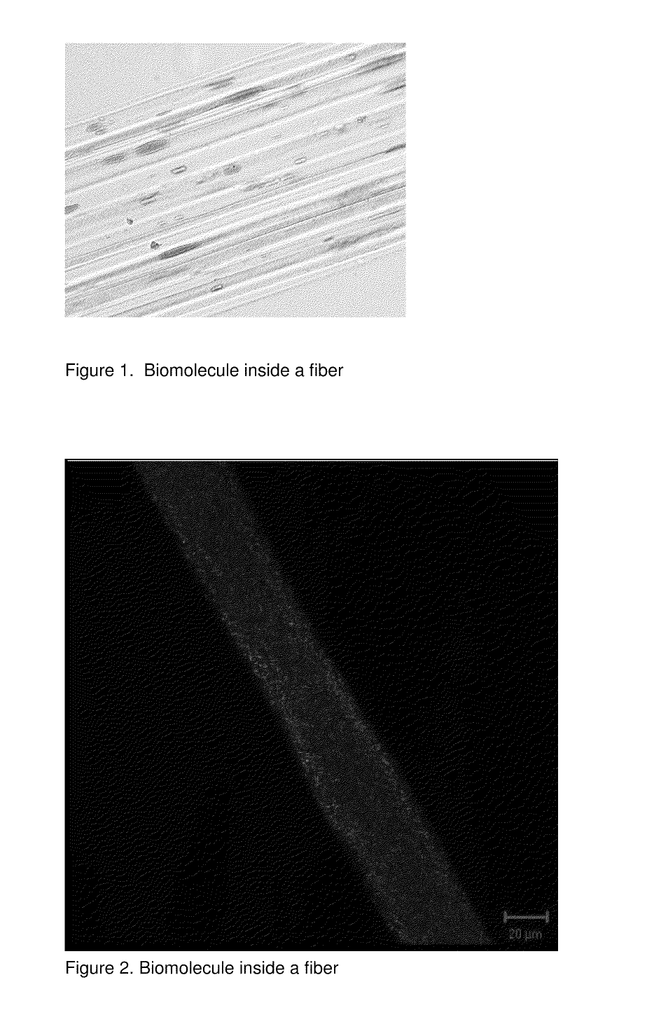

In the FIG. 1 it is possible to see that even the low (0.25%) amount of biomolecule gives a lot of small particles inside the fibre. The particles were not regularly distributed. The surface of the fibres seemed to be quite even.

In the sonication method, biomolecule was dissoluted in water and this water solution was added to polymer solution by sonicator. The amount of water was 5% from the volume of dichloromethane and the biomolecule amount was 0.25% from the weight of the polymer. The lower polymer concentration (8%) was more suitable for sonication method. The advantage of this method was that the spinneret was not blocking and the whole solution was possible spin. See FIG. 2, the glowing parts of the fiber comprise a biomolecule.

We claim:

1. A method in spinning, comprising:
introducing a first solution comprising a polymer;
introducing a second solution comprising a biomolecule;
combining the first and the second solution into a mixture;
treating the mixture with a sonicator to form a spinning solution; and
wet spinning the spinning solution.

2. The method according to claim 1, wherein the polymer is a biodegradable and bioresorbable polymer.

3. The method according to claim 2, wherein the polymer comprises at least one of polylactic acid, polyglycolic acid, or polycaprolactone.

4. The method according to claim 1, wherein the polymer concentration of the first solution is from 6 to 15 wt-%.

5. The method according to claim 1, wherein the polymer concentration of the first solution is from 8 to 15 wt-%.

6. The method according to claim 1, wherein the biomolecule is a growth factor, a protein, or a peptide.

7. The method according to claim 4, wherein the growth factor is one of the following growth factors: vascular endothelial growth factor, fibroblast growth factors, transforming growth factor, bone morphogenetic proteins or epidermal growth factor.

8. The method according to claim 4, wherein the biomolecule is dissolved in water.

9. The method according to claim 1, wherein the amount of the biomolecule is from 0.1 to 0.4 wt.-% calculated from the amount of the polymer.

10. The method according to claim 1, wherein the amount of the biomolecule is 0.24 to 0.26 wt.-%, calculated from the amount of the polymer.

11. The method according to claim 1, wherein the mixture is treated with sonicator for two to five minutes.

12. The method according to claim 1, wherein the spinning solution is spun through the holes of a spinning nozzle, which holes having a diameter from 50 to 100 μm.
